(19) United States
(12) Patent Application Publication
(10) Pub. No.: US 2010/0277332 A1
(43) Pub. Date: Nov. 4, 2010

(54) ATTACHABLE AND INTERCHANGABLE STUD FINDER

(76) Inventor: PAUL BILLINGS, Yakima, WA (US)

Correspondence Address: LAW OFFICE OF JERRY D. HAYNES , P.A, P.O. Box 350392, Fort Lauderdale, FL, 33335, US

(21) Appl. No.: 12/432,753

(22) Filed: Apr. 30, 2009

(51) Int. Cl. G08B 5/00

(52) U.S. Cl. 340/686.1; 33/263

(57) ABSTRACT

The present invention relates to a mountable stud locating device for locating a stud comprising: a stud locating mechanism; a LED indicator, where the LED indicator lights upon location of the stud; a mounting mechanism to mount the locating device on a hand held device; and a laser beam for pinpointing the position of a stud. The stud locating mechanism includes sensors that utilize either a density variation or radar detection as a method to locate the stud. The stud locating device may be detachably mounted to the hand device, where the mounting mechanism includes the use of a magnetic mounting bracket.

### BACKGROUND OF THE INVENTION

1. Field of Invention

The present invention relates to an attachable stud location device that pinpoints studs behind a wall panel.

2. Description of Related Art

Residential and commercial construction usually involves framing of walls and ceiling with wooden studs. Wood studs are usually 2×4 pieces of lumber. Sheet rock or plywood may be nailed or screwed to the studs during building construction. The position of the stud behind the sheet rock must be pinpointed to effectively put the sheet rock or plywood in place. A stud finder is one means utilized by carpenters to located studs.

A stud finder is a hand held device that is held against the sheet rock to locate the stud. Once the stud is detected the position is marked and a nail is driven through the sheet rock into the stud. Typically nails are driven through sheet rock using a nail gun and occasionally a screw gun may be utilized to hang sheet rock. So, the carpenter must utilize two devices in order to nail the sheet rock to the studs. The process can be time consuming and cumbersome for the carpenter. A number of nails or screws may be required to hold the panels in place, consequently a numerous nails are necessary to form a wall of panels attached to a stud frame. Nail guns speed the process of mounting panels due to the speed at which they can propel nails through the panel into a stud. However use of the stud finder requires the use of two hands, which is sometimes difficult in certain situations. Furthermore, the carpenter must keep track of the stud finder through the working day.

The prior art discloses essentially three types of stud finders: 1) magnetic stud finders that detect the nails or screws placed into studs during the manufacturing of the wall; 2) density based stud finders that utilize an internal capacitor plate to detect changes in the dielectric constant of the wall as the user moves the finder over the surface of the wall, a significant change in the dielectric constant indicates a dense object behind the wall, i.e., a stud; and 3) a small radar stud finder that indicates the exact location of a stud are behind the sheet rock.

In general two types of density based stud finders are utilized. The initial designs of the density stud finder detected the edges of the stud behind the sheet rock. The edge stud finder detects when it's directly over a change in density, such as the edge of a stud. Consequently, such stud finders must be moved from both right and left directions to find both edges so the center can be determined. More recent designs of stud finder detect the center of the stud. This type of stud finder determines the wall's dielectric constant from multiple sensors, and uses the different readings to determine the location of the target center. As opposed to edge stud finders, the more recent stud finders do not require movement from both directions to indicate the center of the stud.

The prior art also discloses nail guns that are integrated with a permanently attached stud finder, such as Reference WO/2007/002542 (hereinafter “542 disclosure”). The '542 disclosure describes an integrated stud finder/nail gun where the stud finder includes a display and a stud sensor. The stud finder is permanently attached to the top of the housing of the nail gun. Indicator lights on the stud finder include a color scale that provides a means to indicate the proximity of the stud. The scale goes from red to green with red being indicative of the proximity of the stud. The stud finder of the '542 disclosure utilizes one of the know techniques to located the position of the stud which may include magnetic location, density variation or radar detection.

The drawbacks of the known prior art are readily recognized. Use of individual stud finders requires the use of two devices when mounting sheet rock panels to studs. Stud finders integrated with a nail gun as shown in the '542 disclosure are limited to the device that includes the permanently affixed stud finder. So a carpenter may still need a separate stud finder to use with other hand held devices. It would therefore be advantageous to have a portable and mountable stud finder that could attach to any hand held device used by a carpenter and therefore alleviate the problems with the current prior art.

### SUMMARY OF THE INVENTION

The present invention relates to a mountable stud locating device for locating a stud comprising: a stud locating mechanism; a LED indicator, where the LED indicator lights upon location of the stud; a means for mounting the locating device on a hand held device; and a laser beam for pinpointing the position of a stud. The stud locating mechanism includes sensors that utilize either a density variation or radar detection as a means to locate the stud. The stud locating device may be detachably mounted to the hand device, where the means for mounting includes the use of a magnetic mounting bracket.

### BRIEF DESCRIPTION OF DRAWINGS

FIG. 1A depicts a portable stud finder according to the present invention mounted on a hand held device.

FIG. 1B depicts a portable stud finder according to the present invention mounted on a nail gun.

FIG. 2 depicts a perspective of the portable stud finder according to the present invention.

### DETAILED DESCRIPTION

The present invention relates to a portable stud finder that enables users to locate the position of a stud behind a panel. The stud finder according to the present invention provides a convenient means to locate a stud that may be magnetically attached to a nail gun or other similar hand held device.

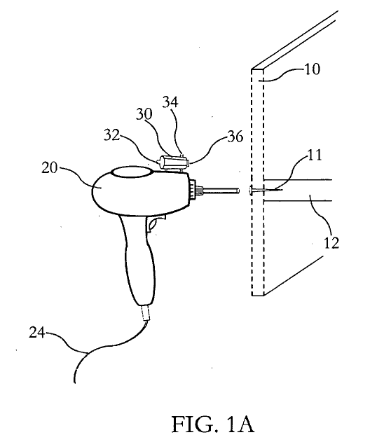

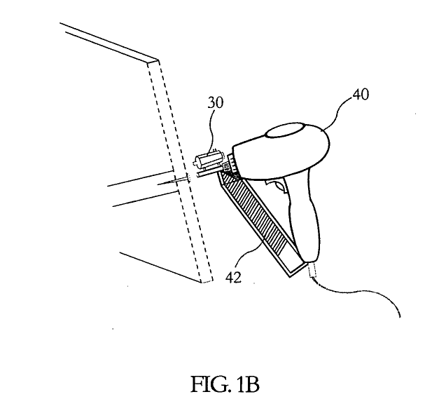

FIG. 1A depicts a stud finder 30 according to the present invention positioned on top of a hand held device 20 where the hand held device 20 may be a screw gun, stapler, drill or nail gun. The hand held device 20 may be used to propel a nail, screw, staple or other penetrating tool through a wall panel 10 into a stud 12. In one exemplary embodiment, the stud finder 30 may be magnetically attached to the device 20. The stud finder 30 may be utilized with any pneumatic air device as depicted in FIG. 1, also the stud finder 30 may be attached to any other hand held device that may be electric or battery operated. The device 20 includes an air supply hose 24 that is used to propel the shot through the nail or screw 11 through the panel 10 into the stud 12.

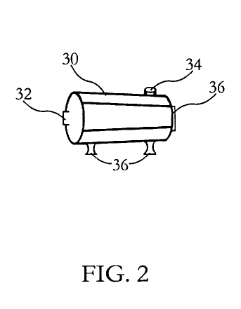

The stud finder 30 is depicted in FIG. 2 where the features thereof are more clearly visible. The finder 30 may utilize the any of the existing location principles discussed above, either density location or radar detection, in order to locate the stud's position behind the wall panel 10. The stud finder 30 includes an LED indicator 32 and a laser beam 34. Upon location of the stud 12, the LED indicator 32 lights and the laser beam 34 pinpoints the position of the stud 12. The finder 30 utilizes the latest density location technology or a radar detection system and therefore the finder 30 pinpoints the center of the stud. The finder 30 therefore finds the stud without the necessity of moving the finder in two directions. A density sensor or radar sensor 36 is positioned at the front end of the finder 30.

The mounting of the stud finder is accomplished by the use of a magnetized mounting piece on the underside of the stud finder 30. This mounting piece attaches the stud finder securely to the nail gun and is able to withstand any vibration that may be caused as a result of the use of any hand held device gun. In addition to using magnetism, the finder 30 may include a mounting bracket or mechanism that uses straps or clip on attachments to mount the finder 30 to a hand held device.

In one exemplary embodiment, the stud finder 30 may be mounted to a nail gun 40 as depicted in FIG. 1B. The nail gun 40 includes a cartridge of nails 42 where the nail gun 40 may be electrically or pneumatically powered. The nail gun 40 uses pressurized air in order to propel the nail through the panel and into the stud. The stud finder 30 also includes a means to power the electronics associated with the stud finder 30. In one particular embodiment, the stud finder 30 may be powered through the use of a battery within a storage compartment of the stud finder 30. The advantage of the stud finder 30 according to the present invention is its ability to be attached and detached to multiple devices in order to perform the stud finding function. The stud finder 30 may be easily attached to a screw gun, stapler, a nailer or any portable handheld device that may require location of a stud behind a wall panel. The instant invention has been shown and described in what is considered to be the most practical and preferred embodiments. It is recognized, however, that departures may be made there from within the scope of the invention and that obvious modifications will occur to a person skilled in the art.

What is claimed is:

1. A mountable stud locating device for locating a stud comprising:
a. a stud locating mechanism;
b. a LED indicator, where the LED indicator lights upon location of the stud;
c. a means for mounting the locating device on a hand held device; and
d. a laser beam for pinpointing the position of a stud.

2. The stud locating device according to claim 1 further comprising, where said stud locating mechanism includes sensors that utilize at least one of a density variation and radar detection as a means to locate the stud.

3. The stud locating device according to claim 1, where the stud locating device is detachably mounted to the hand held device.

4. The stud locating device according to claim 1, where the means for mounting includes use of a magnetic mounting bracket.

5. The stud locating device according to claim 4, where the mounting bracket is positioned on the under side of the locating device.

6. The stud locating device according to claim 1, where the LED indicator is positioned at the rear of the device and stud location sensors are position at the front of the locating device.

7. The stud locating device according to claim 1, where the hand device is at least one of a nail gun, screw gun and stapler.

8. The stud locating device according to claim 1, further comprising a power source, where said power source includes self-contained batteries.
